(19) United States
(12) Patent Application Publication
(10) Pub. No.: US 2009/0266572 A1
(43) Pub. Date: Oct. 29, 2009

(54) HAND-HELD POWER TOOL, IN PARTICULAR A ROTARY HAMMER AND/OR CHISEL HAMMER

(76) Inventors: Gerhard Meixner, Filderstadt (DE); Ralph Dammertz, Mr. Prospect, IL (US); Juergen Lennartz, Ostfildern (DE)

Correspondence Address: MICHAEL J. STRIKER, 103 EAST NECK ROAD, HUNTINGTON, NY, 11743, US

(21) Appl. No.: 11/911,178

(22) PCT Filed: Oct. 27, 2006
(86) PCT No.: PCT/EP2006/067884

§ 371 Date: Oct. 10, 2007

(30) Foreign Application Priority Data
Dec. 22, 2005 (DE) 102005061399.3

(51) Int. Cl. B23B 45/16; B25D 16/00

(52) U.S. Cl. 173/205

(57) ABSTRACT

The invention relates to a hand power tool, in particular a drill hammer and/or chipping hammer, comprising a hammer unit (10a; 10b) for producing a pulse in the direction of a hammer axis (12a; 12b). Said tool has an axial drive unit (14a; 14b) with a drive element (16a; 16b) and a motor unit (18a; 18b), in addition to a motor shaft (20a; 20b), which forms an angle (22a; 22b) not equal to zero with the hammer axis (12a; 12b) and which co-operates with the axial drive unit (14a; 14b) by means of a torque transmission wheel (24a; 24b) of said unit, the axial drive unit (14a; 14b) being mounted on the opposite side of the torque transmission wheel (24a; 24b) from the motor unit (18a; 18b). The driven element (16a; 16b) of the axial drive unit (14a; 14b) is mounted directly on the torque transmission wheel (24a; 24b).

### RELATED ART

The present invention is directed to a hand-held power tool according to the definition of the species in claim 1.

Publication DE 102 59 566 A1 makes known a hand-held power tool designed as a chisel hammer that includes an impact mechanism for generating an impulse in the direction of an axis of impact. The impact mechanism includes an axial drive unit formed by an eccentric unit, with a driven element formed by an eccentric peg. The hand-held power tool also includes a motor unit designed as an electric motor, the motor shaft of which forms an angle of 90° with the axis of impact, and which is operatively connected with the axial drive unit via a torque transmission wheel of the axial drive unit, the torque transmission unit being designed as a gear wheel. The axial drive unit is supported on the side of the gearwheel facing away from the motor unit. On a side facing the motor unit, the gearwheel is abutted by a crankshaft of the axial drive unit and/or the eccentric unit, on the end face—facing the motor unit—of which the driven element or eccentric peg is located.

### ADVANTAGES OF THE INVENTION

The present invention is directed to a hand-held power tool, in particular a rotary hammer and/or chisel hammer, with an impact mechanism for generating an impulse in the direction of an axis of impact, which includes an axial drive unit with a driven element, and with a motor unit and a motor shaft that form an angle with the axis of impact not equal to zero, and which is operatively connected with the axial drive unit via a torque transmission wheel of the axial drive unit, the axial drive unit being supported on the side of the torque transmission wheel facing away from the motor unit.

It is provided that the driven element of the axial drive unit is located directly on the torque transmission wheel. An “axial drive unit” refers, in particular, to a unit that converts a rotational motion into an axial motion, such as a cam mechanism and/or, particularly advantageously, an eccentric unit, which may be realized with a simple, space-saving, and robust design. A “driven element” refers to an element that brings about at least a portion of a conversion of the rotational motion to axial motion via, in particular, its shape and/or, in particular, its location. Examples include an eccentric peg or a cam with a matching eccentric recess, etc., and which forms an interface with a transmission unit provided for transmitting a drive force of the axial drive unit to a piston unit, such as a connecting rod unit and/or a push unit that are/is guided on a curved path of the axial drive unit. A “torque transmission wheel” refers, in particular, to a wheel that is provided to transmit torque, such as a wheel that is provided for coupling with a belt, and/or, particularly preferably, a gearwheel, etc. Furthermore, a location “directly next to the torque transmission wheel” refers, in particular, to a design without an intermediate shaft, such as a crankshaft in particular, and/or to a location next to a torque transmission element of the torque transmission wheel, of a tooth system in particular, with a separation in the axial direction of the torque transmission wheel that is less than its extension in the axial direction. The driven element may be designed as a single component or with multiple components, and it may include connecting means in particular, such as sleeves, which may be provided to be fastened to the torque transmission wheel and/or for damping, etc. Particularly preferably, however, the driven element is designed as a single piece and is integrally moulded directly with the torque transmission wheel, or it is mounted directly thereon. “Provided” is intended to mean, in particular, specially equipped and/or designed.

An inventive embodiment of this type saves installation space and weight, and a particularly compact design may be attained, in particular when an axial drive unit is supported on one side, relative to the torque transmission wheel in particular.

Furthermore, components, installation space, weight, assembly expense and costs may be saved when the hand-held power tool includes a rotary drive unit that is provided for rotationally driving a tool and that is designed at least partially as a single piece with the axial drive unit, preferably when the torque transmission wheel of the axial drive unit is supported on a shaft of the rotary drive unit.

In a further embodiment of the present invention, it is provided that the impact mechanism includes a transmission unit, which is provided to transmit a drive force from the axial drive unit to a piston unit, the transmission unit including vertically offset joints. “Displaced vertically” refers, in particular, to a distance in a direction that is not an axial direction or an impact direction, and which extends in the direction of a bearing axis of the hand-held power tool, e.g., particularly preferably in the direction of a motor axis or an axis of rotation of the motor shaft. The distance between the joints and/or between the centers of the joints is preferably greater than half of a longitudinal extension of at least one joint, and particularly preferably, is greater than an entire longitudinal extension of a joint. A “joint” refers, in particular, to a point at which the transmission unit is coupled with the axial drive unit, and to a point at which the transmission unit is coupled with the piston unit. With an inventive embodiment of this type, a particularly flexible design of installation space may be attained, and installation space—height, in particular—may be saved overall.

Vertically offset joints may be attained using a simple design and in a cost-favorable manner when the transmission unit includes at least one transmission element, which has—in at least one subregion—an orientation that extends diagonally to the axis of impact and brings about a vertical offset between the joints.

When the motor unit is supported via motor bearing points before and after—in the direction of the motor shaft—its center of mass, a large distance between the motor bearing points and the motor unit may be attained, and the motor unit may be advantageously supported with bearings—that are sizeable in a cost-favorable manner—in particular when the motor unit includes a pinion located between—in the direction of the motor shaft—the motor bearing points. A “motor unit” refers, in particular, to a unit in which one form of energy, such as flow energy and preferably electrical energy, is converted to rotational energy, such as a rotor and a stator, in particular, of an electric motor, etc. “Motor bearing points” refers in particular to bearing points at which the parts of the motor unit are supported, such as the stator and/or rotor, in particular, of an electric motor, e.g., via a motor shaft, etc.

It is further provided that the hand-held power tool includes a sealing unit located between the motor bearing points in the direction of the motor shaft. A “sealing unit” refers, in particular, to a unit that seals off a motor compartment from lubricant. A sealing unit located in this position may have a particularly simple design, in particular when it includes an intermediate cover.

### DRAWING

Further advantages result from the description of the drawing, below. Exemplary embodiments of the present invention are shown in the drawing. The drawing, the description and the claims contain numerous features in combination. One skilled in the art will also advantageously consider the features individually and combine them to form further reasonable combinations.

FIG. 1 shows a schematicized longitudinal sectional view of a hand-held power tool designed as a chisel hammer, and

FIG. 2 shows a schematicized longitudinal sectional view of a hand-held power tool designed as a rotary hammer.

### DESCRIPTION OF THE EXEMPLARY EMBODIMENTS

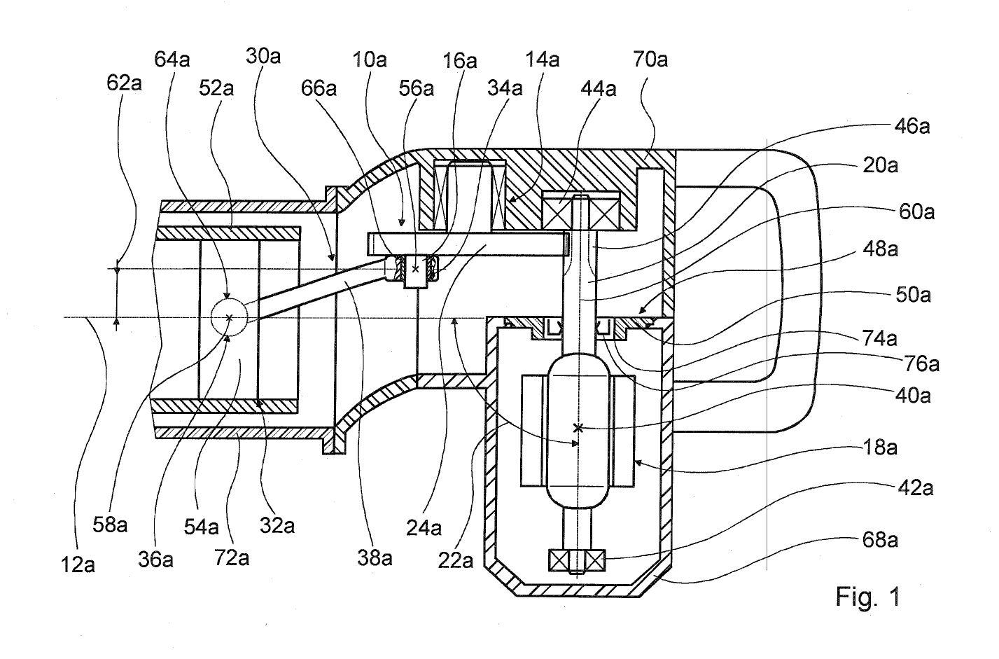

FIG. 1 shows a schematicized longitudinal sectional view of a hand-held power tool designed as a chisel hammer with an impact mechanism 10a, which serves to generate an impulse in the direction of an axis of impact 12a. Impact mechanism 10a includes an axial drive unit 14a designed as an eccentric unit, with a driven element 16a designed as an eccentric peg. Impact mechanism 10a also includes a transmission unit 30a, which is provided to transmit a drive force from driven element 16a of axial drive unit 14a to a piston unit 32a and/or to a piston 54a, which is guided in a hammer tube 52a. Transmission unit 30a is formed essentially by a transmission element 38a designed as a connecting rod, and includes vertically offset joints 34a, 36a formed by connecting rod ends. Joints 34a, 36a, i.e., their centers 56a, 58a, formed by the connecting rod ends are separated—in the direction of a motor axis 60a or an axis of rotation of a motor shaft 20a of a motor unit 18a designed as an electric motor—by a distance 62a that preferably corresponds to one-half of an extension of a joint 34a, 36a in the direction of motor axis 60a. To attain a vertical offset essentially from joint 34a facing axial drive unit 14a to joint 36a facing piston unit 32a, transmission element 38a is orientated diagonally to axis of impact 12a. It would also be feasible in principle, however, for transmission element 38a to be designed coaxial or parallel with axis of impact 12a, as viewed perpendicularly to motor axis 60a and/or in the side view shown.

The hand-held power tool has an L shape, in which motor axis 60a and/or motor shaft 20a form(s) an angle 22a of 90° with axis of impact 12a. Other angles that are not zero and that appear reasonable to one skilled in the art are also feasible, such as angles between 30° and 150° in particular. An orientation of motor shaft 20a that is coaxial or parallel with axis of impact 12a is considered to be an angle equal to zero.

Transmission element 38a is coupled with piston 54a in joint 36a facing piston unit 32a via a spherical head mounting 64a, and it is coupled in joint 34a facing axial drive unit 14a via a ball journal bearing 66a with driven element 16a—designed as an eccentric peg—of axial drive unit 14a.

Motor unit 18a is located in a motor housing 68a, which, in the direction toward axial drive unit 14a, abuts a transmission housing 70a formed by a first component, and, in the direction toward piston unit 32a, abuts a hammer tube housing 72a formed by a further component. As an alternative, transmission housing 70a and hammer tube housing 72a may also be designed as single pieces. A shell design is also possible, in which the functional assemblies are enclosed—either entirely or partially—by two half shells. Motor unit 18a could also be accommodated in a half shell.

Motor shaft 20c extends beyond a core of motor unit 18a in both directions and is supported at one end—facing away from axial drive unit 14a—in motor housing 68a via a first motor bearing point 42a, and, at an end facing axial drive unit 14a, is supported via a second motor bearing point 44a and, in fact starting from motor unit 18a designed as an electric motor in the axial direction of motor axis 60a behind a motor pinion 46a integrally moulded with motor shaft 20a and behind a torque transmission wheel 24a of axial drive unit 14a, which meshes with motor pinion 46a and is designed as a spur gear. As an alternative, motor bearing point 44a could be located in front—starting at motor unit 18a and extending along motor shaft 20a—of motor pinion 46a. Motor unit 18a is supported by motor bearing points 42a, 44a before and after—in the direction of motor shaft 20a—of its center of mass 40a.

The hand-held power tool includes a sealing unit 48a, which is located between—in the direction of motor shaft 20a—motor bearing points 42a, 44a in motor housing 68a, and which includes an intermediate cover 50a with a recess 74a, through which motor shaft 20a is guided. An annular seal 76a, which serves as a seal between motor shaft 20a and intermediate cover 50a, is located in recess 74a. Annular seal 76a seals off a motor compartment in motor housing 68a from a transmission compartment in transmission housing 70a. As an alternative, a sealing ring could also be installed directly in a motor housing—which would be designed accordingly—and/or directly in a transmission housing.

Axial drive unit 14a and/or the eccentric are/is supported in transmission housing 70a on one side—relative to torque transmission wheel 24a—on a side of torque transmission wheel 24a facing away from motor unit 18a, while, on the side of torque transmission wheel 24a facing motor unit 18a, driven element 16a—which is designed as a single-pieced eccentric peg—of axial drive unit 14a is located directly on torque transmission wheel 24a and is fastened directly thereto.

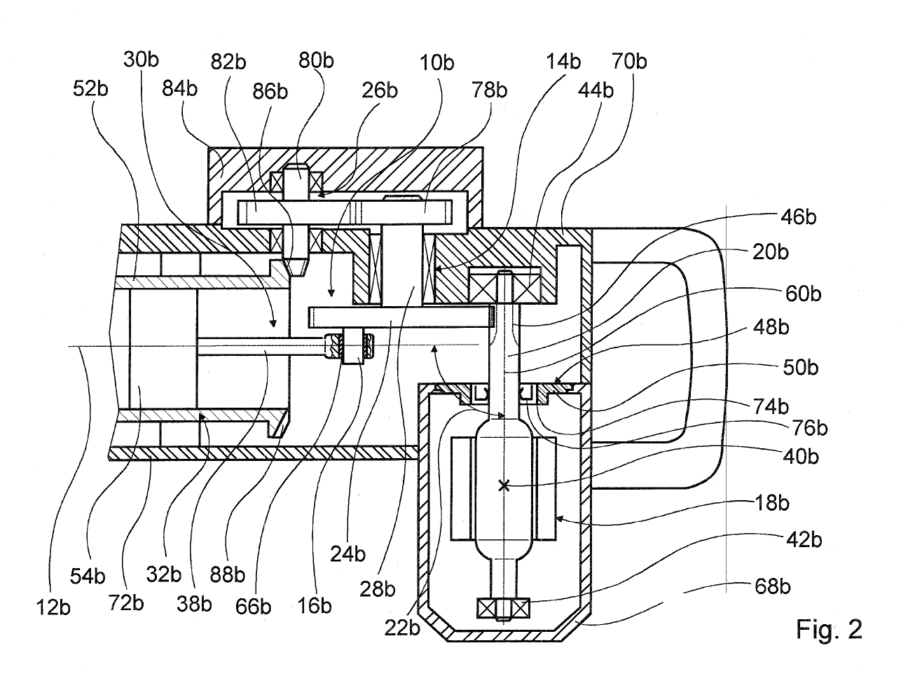

A further exemplary embodiment is shown in FIG. 2. Components and functions that are essentially the same are labeled with the same reference numerals, but appended with a or b, to differentiate the two exemplary embodiments. The description below is essentially limited to the differences from the exemplary embodiment in FIG. 1. With regard for the components, features, and functions that are identical, reference is made to the description of the exemplary embodiment in FIG. 1.

FIG. 2 shows a schematicized longitudinal sectional view of a hand-held power tool designed as a rotary hammer, which—unlike the hand-held power tool shown in FIG. 1—also includes a rotary drive unit 26b, which is provided to rotationally drive a tool, i.e., a drilling tool. Rotary drive unit 26b is designed partially as a single piece with an axial drive unit 14b. In fact, a torque transmission wheel 24b of axial drive unit 14b is provided as the drive element of rotary drive unit 26b. Torque transmission wheel 24b, which is designed as a spur gear, is mounted on a shaft 28b of rotary drive unit 26b, on the end—facing away from torque transmission wheel 24b—of which an intermediate wheel 78b is mounted. During operation, torque is transmitted via shaft 28b from torque transmission wheel 24b to intermediate wheel 78b.

Intermediate wheel 78b meshes with a gearwheel 82b that is also mounted on a shaft 80b. On a side facing away from a hammer tube 52b, shaft 80b is supported in a cover 84b, and, on a side facing hammer tube 52b, it is supported in a hammer tube housing 72b. A pinion 86b is integrally moulded with an end facing hammer tube 52b. Pinion 86b meshes with a crown wheel 88b integrally moulded with hammer tube 52b. As an alternative, crown wheel 88b could also be designed as a component that is separate from hammer tube 52b, that could be secured to hammer tube 52b or connected with hammer tube 52b via interlocking.

### REFERENCE NUMERALS

10 Impact mechanism
12 Axis of impact
14 Axial drive unit
16 Driven element
18 Motor unit
20 Motor shaft

### 22 Angle

24 Torque transmission wheel
26 Rotary drive unit

### 28 Shaft

30 Transmission unit
32 Piston unit

### 34 Joint

### 36 Joint

38 Transmission element
40 Center of mass
42 Motor bearing point
44 Motor bearing point
46 Motor pinion
48 Sealing unit
50 Intermediate cover
52 Hammer tube

### 54 Piston

### 56 Center

### 58 Center

60 Motor axis

### 62 Distance

64 Spherical heaad mounting
66 Ball journal bearing
68 Motor housing
70 Transmission housing
72 Hammer tube housing

### 74 Recess

76 Annular seal
78 Intermediate wheel

### 80 Shaft

### 82 Gearwheel

### 84 Cover

### 86 Pinion

88 Crown wheel

What is claimed is:

1. A hand-held power tool, in particular a rotary hammer and/or chisel hammer, with an impact mechanism (10a; 10b) for producing an impulse in the direction of an axis of impact (12a; 12b), and with an axial drive unit (14a; 14b) with a driven element (16a; 16b) and a motor unit (18a; 18b), and with a motor shaft (20a; 20b), which forms an angle (22a; 22b) not equal to zero with the axis of impact (12a; 12b), and which cooperates with the axial drive unit (14a; 14b) via a torque transmission wheel (24a; 24b) of axial drive unit (14a; 14b), the axial drive unit (14a; 14b) being supported on the side of the torque transmission wheel (24a; 24b) facing away from the motor unit (18a; 18b),
wherein
the driven element (16a; 16b) of the axial drive unit (14a; 14b) is located directly on the torque transmission wheel (24a; 24b).

2. The hand-held power tool as recited in claim 1,
wherein
the axial drive unit (14a; 14b) is supported on one side.

3. The hand-held power tool as recited in claim 1, characterized by a rotary drive unit (26b), which is provided for rotationally driving a tool, and which is designed at least partially as a single piece with the axial drive unit (14b).

4. The hand-held power tool as recited in claim 3,
wherein
the torque transmission wheel (24b) of the axial drive unit (14b) is provided as a means to drive the rotary drive unit (26b).

5. The hand-held power tool as recited in claim 4,
wherein
the torque transmission wheel (24b) of the axial drive unit (14b) is supported on a shaft (28b) of the rotary drive unit (26b).

6. The hand-held power tool as recited in claim 1,
wherein
the axial drive unit (14a; 14b) is formed by an eccentric unit.

7. The hand-held power tool as recited in claim 1,
wherein
the impact mechanism (10a) includes a transmission unit (30a), which is provided to transmit a drive force from the axial drive unit (14a) to a piston unit (32a), the transmission unit (30a) including vertically offset joints (34a, 36a).

8. The hand-held power tool as recited in claim 7,
wherein
the transmission unit (30a) includes at least one transmission element (38a), which has—in at least one subregion—an orientation that extends diagonally to the axis of impact (12a) and results in a vertical offset between the joints (34a, 36a).

9. The hand-held power tool as recited in claim 1,
wherein
the motor unit (18a; 18b) is supported via motor bearing points (42a, 44a; 42b, 44b) before and after—in the direction of the motor shaft (20a; 20b)—its center of mass (40a; 40b).

10. The hand-held power tool as recited in claim 9,
wherein
the motor unit (18a; 18b) includes a motor pinion (46a; 46b) located between the motor bearing points (42a, 44a; 42b, 44b) in the direction of the motor shaft (20a; 20b).

11. The hand-held power tool as recited in claim 9, characterized by a sealing unit (48a; 48b), which is located between—in the direction of the motor shaft (20a; 20b)—the motor bearing points (42a, 44a; 42b, 44b).

12. The hand-held power tool as recited in claim 11,
wherein
the sealing unit (48a, 48b) includes an intermediate cover (50a; 50b).
